(19) United States
(12) Patent Application Publication
(10) Pub. No.: US 2004/0170399 A1
(43) Pub. Date: Sep. 2, 2004

(54) Digital data storage and access

(75) Inventors: Alvar Bray, Bristol (GB); Marcus Jones, Lincoln (GB)

Correspondence Address: ARENT FOX KINTNER PLOTKIN & KAHN, 1050 CONNECTICUT AVENUE, N.W., SUITE 400, WASHINGTON, DC, 20036, US

(73) Assignee: Zarlink Semiconductor Limited

(21) Appl. No.: 10/776,314

(22) Filed: Feb. 12, 2004

(30) Foreign Application Priority Data
Feb. 12, 2003 (GB) GB 0303110.1

(51) Int. Cl. H04N 5/781

(52) U.S. Cl. 386/125; 386/126

(57) ABSTRACT

A device for storing and accessing digital video data comprises first processing means 1 for implementing an operating system and a video system. A hard disk drive 7 is partitioned to provide a video file system storage area and an operating system file system storage area. A Hard Disk Drive Controller 8 controls access to the hard disk drive 7, the Hard Disk Drive Controller 8 comprising at least one register 14 for storing parameters defining a hard disk drive access operation and indicating the status of that operation. Two further registers 12,13 are associated with the video system and the operating system respectively, each further register being arranged to store parameters defining a hard disk drive access operation received from the associated system, and parameters indicating the status of that operation. Second processing means exchanges parameters between the register 14 of the Hard Disk Drive Controller 8 and those of said two further registers 12,13.

### FIELD OF THE INVENTION

The present invention relates to digital data storage and access and more particularly, though not necessarily, to a method and apparatus for storing digital video data and for accessing stored digital video data.

Traditionally, video data has been stored on video tape using video tape recorders. With the advent of digital television however, digital video storage devices making use of hard disk drives (HDDs) are being introduced. It can be expected that in the near future such storage devices will become commonplace in both the home and commercial environments. As well as being available as stand alone recording machines, storage devices using hard disk drives are likely to be integrated into digital set top boxes for receiving and decoding cable, satellite and terrestrial television signals, and into televisions themselves.

Digital video storage devices incorporating HDDs will make use of the latest computer related technologies. Indeed, it will be desirable to allow these devices to make use of current standard operating systems such as Linux and Microsoft Windows™ in order to simplify the development process, reduce costs, and provide open platforms (e.g. so that the devices can run third party applications). The chosen operating system will be able to make use of the same HDD which is used to store the digital video file system, to maintain the root file system storing for example MP3 files, drivers, applications, etc.

Standard operating systems such as Windows are designed to work satisfactorily with a range of hardware and software architectures. This tends to lead to a less than optimal performance on any given architecture. Consider a typical architecture in which a Hard Disk Drive Controller (HDDC) provides the interface for the computer system to the HDD. A Direct Memory Access (DMA) controller is responsible for the actual transfer of data between the HDDC and other system components via memory. The DMA handles these transfers in such a way that data does not need to pass through the microprocessor. The Hard Disk Drive Controller (HDDC), e.g. such as Integrated Drive Electronics (IDE), Enhanced IDE (EIDE), and Small Computer Systems Interface (SCSI), can typically access the HDD within say 20 mS. However, the operating system may introduce a significant overhead to this access time, resulting in a total access time in excess of 100 mS. For this reason, the operating system is likely to operate side-by-side with a video system which will handle HDD access requests relating to the storage and retrieval of video data which will be stored in a partition of the HDD separate from that used by the operating system. The video system will be optimised for the particular architecture used, and the operating system and the video system will access the HDD via the same HDDC.

### SUMMARY OF THE INVENTION

The inventors of the present invention have recognised that the sharing of the HDDC by the video and operating systems will require not only a modified video system design (as compared to the design which would be utilised were no operating system in use), but also a modified operating system. Both must be designed to allow some arbitration to take place over use of the shared HDDC. Arbitration is likely to make use of semaphores, i.e. current status flags, which are maintained and accessed by code shared between the operating and video system software, to determine the status of the HDD and of requests being processed by the HDDC.

The need to modify standard software, such as for example Linux or Windows, is undesirable and in some cases impractical. The need for arbitration, including the repeated checking of the semaphores and/or the need to send interrupts from the DMA controller to the video or operating system, is also likely to add significantly to the HDD access time. This is especially problematic for the video system where fast HDD access is an important requirement. Yet another disadvantage of this approach is that the video and operating systems will be less able to handle other tasks while a HDDC access request is being processed, given their active involvement in the arbitration process.

It is an object of the present invention to overcome or at least mitigate the disadvantages noted in the preceding paragraph. This and other objects are achieved by the provision of pseudo HDDC register sets for each of the video and operating systems.

According to a first aspect of the present invention there is provided a device for storing and accessing digital data and comprising:

a hard disk drive partitioned to provide a separate file storage area for each of a plurality of applications or processing elements;

a Hard Disk Drive Controller for controlling access to the hard disk drive, the Hard Disk Drive Controller comprising at least one register for storing parameters defining a hard disk drive access operation and indicating the status of that operation;

at least two further registers corresponding in number to the number applications or processing elements, each further register arranged to store parameters defining a hard disk drive access operation received from the associated application/processing element, and parameters indicating the status of that operation; and

processing means for exchanging parameters between the register of the Hard Disk Drive Controller and those of said two further registers.

The registers associated with the applications act as pseudo or proxy Hard Disk Drive Controller (HDDC) configuration registers, each providing a virtual memory access (e.g. DMA channel). This results in each of the video and operating system believing that it has sole use of the HDDC and hard disk drive. These systems therefore do not need to be modified over systems used in standalone architectures, and because the systems are not involved in arbitration procedures to determine who can use the HDDC and when, hard disk drive access speeds are not as compromised as they would be if a software solution using semaphores were to be employed, since the “hardware” solution removes any interrupt latencies.

Preferably, said processing means and said further configuration registers are implemented using hardware.

Preferably, said processing means monitors read and write operations to the further registers, and arbitrates access to the Hard Disk Drive Controller.

Preferably, said processing means is arranged to facilitate hard disk drive access to each of said applications/processing elements in turn, transferring parameters identifying the data to be accessed from the further registers to the register of the Hard Disk Drive Controller, and transferring status data from the Hard Disk Drive Controller registers to the further registers, and interrupts to the applications/processing elements.

In a preferred embodiment of the invention, the disk is partitioned to provide a storage area for a plurality of applications, the applications including at least an operating system and a video system, the latter making use of the hard disk to store digital video data. Preferably, the device includes one or more processing means for implementing said applications.

According to a second aspect of the present invention there is provided a method of accessing and storing digital data on a hard disk drive, the hard disk drive being partitioned to provide separate file storage areas for each of a plurality of applications/processing elements, the method comprising:

writing data defining disk access requests from said applications/processing elements to respective pseudo Hard Disk Drive Controller registers;

exchanging access request data and status data between the pseudo registers and a Hard Disk Drive Controller register such that at any given time the Hard Disk Drive Controller is actioning an access request from one of the applications/processing elements.

### BRIEF DESCRIPTION OF THE DRAWINGS

FIG. 1 illustrates schematically a digital video storage device;

FIG. 2 illustrate schematically a part of the device of FIG. 1; and

FIG. 3 is a flow diagram illustrating a method of operation of the device of FIG. 1.

### DETAILED DESCRIPTION OF CERTAIN EMBODIMENTS

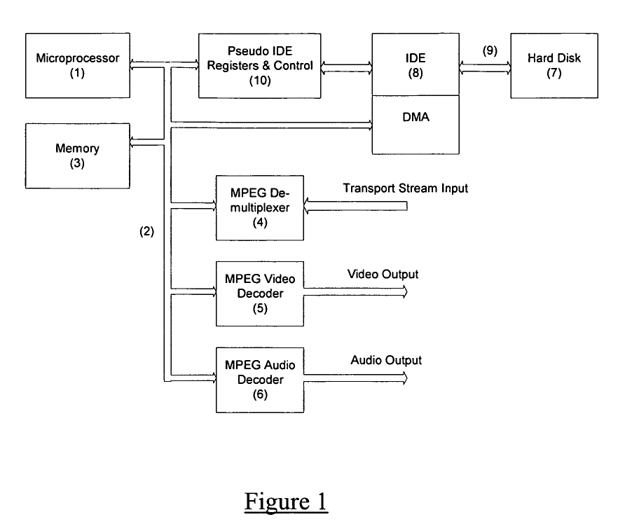

There is illustrated in FIG. 1 a hardware architecture for a digital video storage device. This might be a stand alone unit or might form part of a larger system such as a set top box for receiving and decoding digital cable or satellite broadcasts. The device comprises a microprocessor 1 coupled to an address and data bus 2. The microprocessor runs an operating system such as Linux or Windows, and the video recording software which is typically a proprietary application written by or for the manufacturer of the recorder. A memory 3 is also connected to the bus 2 and is used by the operating system. The memory also provides for buffering of transport streams, and video and audio data.

The other components of the recorder (coupled to the data and address bus 2 unless otherwise indicated) are:

MPEG De-multiplexer 4: This receives the transport stream from the tuner/demodulator and will filter the required video and audio MPEG streams into buffers in the memory. The de-multiplexer also filters the system information tables that allow the Operating System software to display menus for choosing programs and channels to the user.

MPEG Video Decoder 5: This reads data from the video stream buffered in memory (from the de-multiplexer), and decodes the compressed data. The output from this block 5 can then be fed to the display hardware.

MPEG Audio Decoder 6: This reads data from the audio stream buffered in memory (from the de-multiplexer), and decodes the compressed data. The output from this block can then be fed to the audio output hardware.

Hard Disk 7: This block contains the physical disk drive. On a top-end entertainment centre this could hold MP3 music files, video files, photographs, Internet cache and many other files. The operating system would therefore maintain a standard file system, such as FAT or EXT2FS, for the storage of non-video data and the video recording software would have a separate partition to hold compressed video and audio stream data. The two would be separate since the performance of the standard OS file system is not typically sufficient to provide smooth video output in an embedded system. (In an embedded system the processor is not as powerful as in an average desktop PC)

DMA/IDE 8: This block provides the necessary hardware to initialise and communicate with the hard disk drive. When data is read or written to the disk the IDE hardware makes use of Direct Memory Access mechanisms to efficiently transfer data to and from the memory. The DMA/IDE may be integrated into a chip also providing other components of the system, e.g. the microprocessor 1, or may be provided on a separate chip. The DMA/IDE is coupled to the hard disk 7 by a bus 9. Although the example described here makes use of IDE, it will be appreciated that the invention may be applied to systems using other drive interface standards including EIDE (Enhanced IDE) and SCSI (Small Computer Systems Interface).

The DMA channel enables the direct transfer of data between the hard disk 7 and other components of the recorder, i.e. the data does not need to pass through the microprocessor 1. This leaves the microprocessor free to perform other tasks once a data transfer has been initiated. The HDDC 8 comprises one or more hardware registers which in use store:

Status bit(s);

at least one status bit is set to indicate whether the IDE is active or inactive,

Configuration bits;

for hard disk access operation in progress, these bits identify the source and destination addresses and the block size for the data transfer,

The DMA 8 provides an interrupt IRQ which is intended for the microprocessor and which indicates when a disk access operation has been completed. This interrupt is generated by the DMA channel when an IDE access operation has been completed.

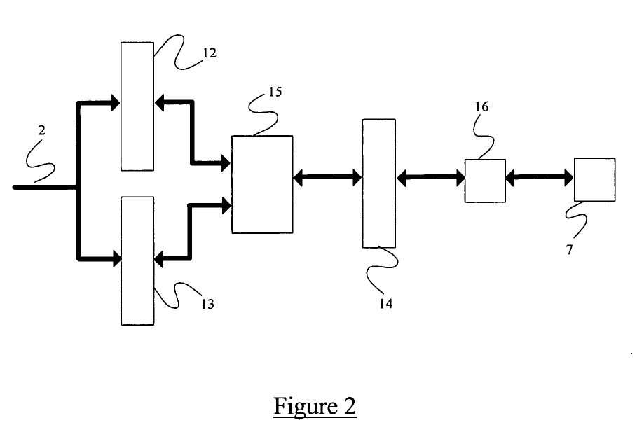

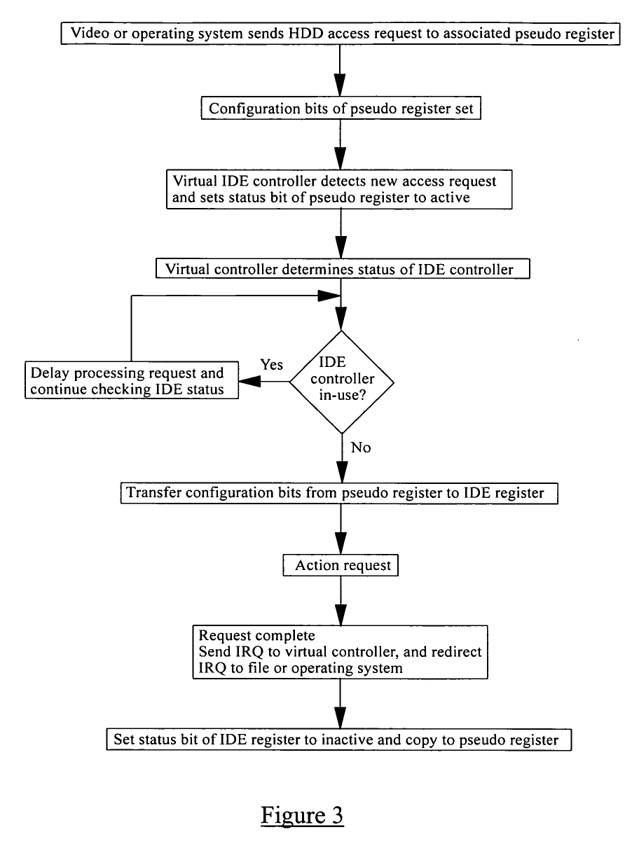

A new hardware block 10 is coupled to the data and address bus 2, between that bus and the IDE 8. The internal architecture of this block 10 is shown in more detail in FIG. 2, and comprises a pair of identical “pseudo” registers 12,13 coupled to the bus 2. These registers have different addresses, with the operating system run by the microprocessor being “programmed” with a first address which identifies a first of the pseudo registers 12, and the video system being programmed with a second address which identifies the other pseudo register 13. In the video and operating systems, these addresses replace the IDE register address which would be used in conventional systems. The file and operating systems are unaware of the “re-direction” of their requests, and that they do not have direct access to the register of the IDE 8 (this register is shown in FIG. 3, identified by the reference numeral 14). The bits of each of the pseudo registers 12,13 are mapped to the bits of the register 14 of the IDE, such that each pseudo-register provides a set of pseudo status bits and a set of pseudo configuration bits.

A controller 15 is responsible for the transfer of data between the pseudo registers 12,13 and the IDE register 14. Another function of the controller 15 is to route IRQ interrupts from the DMA to the operating system or the video system depending upon whether a completed operation related to an operating system or video system access request. Consider the case where the operating system wishes to read from or write to the hard disk 7. Assuming that the operating system has received an IRQ indicating that the previous access request of the operating system has been completed, the operating system will write the necessary information, i.e. source and destination address and block size, to the configuration bits of the pseudo register 12.

The controller 15 polls the pseudo register 12 at regular intervals to determine if the virtual DMA channel has been enabled. If the controller 15 determines that this is the case, it then changes the status bit of the pseudo register 12 to indicate that the virtual DMA channel is active. The controller then checks the corresponding status bit of the IDE register 14. In the event that this indicates that the real DMA channel is inactive, the configuration bits of the first pseudo register 12 are loaded into the corresponding configuration bits of the IDE register 14. The status bit of the IDE register will be changed to indicate a DMA channel status of active, and the instruction processed by the IDE 16. When the DMA operation is complete, the status bit of the IDE register 14 will be changed to indicate the new status, and an IRQ passed to the controller 15 causing the controller to map this status bit to the status bit of the first pseudo register, indicating that the disk access operation is complete. The controller will also redirect the IRQ to the operating system. The operating system can then take the next access request from the stack of pending requests, and the process is repeated. The operation of the video system corresponds to that of the operating system vis-á-vis disk access, using the second pseudo register 13 rather than the first register 12.

Consider now the case where a disk access request is written to one of the pseudo registers 12,13, the controller changes the status bit of that register to indicate that the corresponding virtual DMA channel is active, and the controller then determines from a polling of the appropriate status bit of the IDE register that the DMA is active (e.g. an access request is made by the operating system whilst an access request for the video system is being actioned). In this case, the controller will not yet transfer the configuration bits from the pseudo register to the IDE register. Rather, it will continue to poll the status bit of the IDE register until that bit indicates that the current access request is completed and the IDE inactive. At that time, the configuration bits will be transferred from the pseudo register to the IDE register.

In order to ensure equal access to the hard disk drive by both the operating and video systems, the controller 15 will transfer requests from the pseudo registers in turn (i.e. on a round-robin basis), unless of course one of the systems does not have a pending access requests in which case the controller may accept a series of requests from the other of the systems without interruption. In some implementations, one of the operating or video system may be given priority over the other system, to ensure a higher data throughput for the system with the higher priority.

It will be appreciated by the person of skill in the art that various modifications may be made to the above described embodiment without departing from the scope of the present invention. For example, whilst the embodiment described above is concerned with allowing an operating system and a video system to share access to a single hard disk drive, the invention can be applied to other applications requiring such access. The number of applications involved need not be limited to two—the number of pseudo registers would correspond to the number of applications. The invention could also be applied to a plurality of processors sharing access to a common hard disk drive.

1. A device for storing and accessing digital data and comprising:
a hard disk drive partitioned to provide a separate file storage area for each of a plurality of applications or processing elements;
a Hard Disk Drive Controller for controlling access to the hard disk drive, the Hard Disk Drive Controller comprising at least one register for storing parameters defining a hard disk drive access operation and indicating the status of that operation;
at least two further registers corresponding in number to the number applications or processing elements, each further register arranged to store parameters defining a hard disk drive access operation received from the associated application/processing element, and parameters indicating the status of that operation; and
processing means for exchanging parameters between the register of the Hard Disk Drive Controller and those of said two further registers.

2. A device according to claim 1, wherein said processing means and said further configuration registers are implemented using hardware.

3. A device according to claim 1 or 2, wherein said processing means monitors read and write operations to the further registers, and arbitrates access to the Hard Disk Drive Controller.

4. A device according to claim 1, wherein said processing means is arranged to facilitate hard disk drive access to each of said applications/processing elements in turn, transferring parameters identifying the data to be accessed from the further registers to the register of the Hard Disk Drive Controller, and transferring status data from the Hard Disk Drive Controller registers to the further registers, and interrupts to the applications/processing elements.

5. A device according to claim 1, the disk being partitioned to provide a storage area for a plurality of applications, the applications including at least an operating system and a video system, the latter making use of the hard disk to store digital video data.

6. A device according to claim 5 and comprising one or more processing means for implementing said applications.

7. A method of accessing and storing digital data on a hard disk drive, the hard disk drive being partitioned to provide separate file storage areas for each of a plurality of applications/processing elements, the method comprising:
writing data defining disk access requests from said applications/processing elements to respective pseudo Hard Disk Drive Controller registers;
exchanging access request data and status data between the pseudo registers and a Hard Disk Drive Controller register such that at any given time the Hard Disk Drive Controller is actioning an access request from one of the applications/processing elements.
